(19) United States
(12) Patent Application Publication
(10) Pub. No.: US 2016/0286362 A1
(43) Pub. Date: Sep. 29, 2016

(54) METHOD AND SYSTEM TO OBTAIN POSITION ESTIMATION USING A HYBRID PROCESS

(71) Applicant: UMM AL-QURA UNIVERSITY, Makkah (SA)

(72) Inventor: Mohamed KHALAF-ALLAH, Makkah (SA)

(73) Assignee: UMM AL-QURA UNIVERSITY, Makkah (SA)

(21) Appl. No.: 14/670,156

(22) Filed: Mar. 26, 2015

(51) Int. Cl. H04W 4/04; H04W 24/08

(52) U.S. Cl. CPC H04W 4/04; H04W 24/08

(57) ABSTRACT

A system and associated methodology determines the 3D position of an object using a hybrid process. In selected embodiments, the system uses a nuisance parameter calculated based on time difference of arrival measurements obtained from plurality of stations.

### BACKGROUND

Position estimation of an emitter or a receiver of electromagnetic radio wave/signals can be carried out from signal time difference of arrival (TDOA) measurements. Positioning using TDOA measurements has long been and is still of great research interest in many applications, such as cellular networks, intelligent transport systems (ITS), radar and acoustic systems, where the position estimation is computed from a set of intersecting hyperbolic curves generated by the TDOA measurements. When an additive measurement error model is assumed, available approaches include maximum likelihood (ML) and least-squares (LS), which are implemented as iterative or non-iterative (closed-form) algorithms. Another important class of techniques are direct methods (DM) which are algebraic and exact solutions to TDOA equations. However, their accuracy depends heavily on the accuracy of the TDOA measurements and works with a fixed number of equations. The direct methods make use only of the required TDOA measurements. In some instances, DM may be desirable since they do not involve any matrix operations.

The hyperbolic equations obtained from the TDOA measurements are nonlinear. The hyperbolic equations may be linearized by using Taylor series expansion and solved iteratively using the least-squares estimator (LSE) as described in W. Foy, “Position-location solutions by Taylor series estimations,” IEEE Trans. Aerospace and Electronic Systems, vol. 12, pp. 187-194, 1976 and D. Torrieri, “Statistical theory of passive location systems,” IEEE Trans. Aerosp. Electron. Syst., vol. 20, no. 2, pp. 183-197, March 1984, the entire contents of which are herein incorporated by reference.

The foregoing “background” description is for the purpose of generally presenting the context of the disclosure. Work of the inventor, to the extent it is described in this background section, as well as aspects of the description which may not otherwise qualify as prior art at the time of filing, are neither expressly or impliedly admitted as prior art against the present disclosure. The foregoing paragraphs have been provided by way of general introduction, and are not intended to limit the scope of the following claims. The described embodiments, together with further advantages, will be best understood by reference to the following detailed description taken in conjunction with the accompanying drawings.

### SUMMARY

Convergence to a global solution may not be guaranteed, which is dependent on an initial guess of the position estimate required to run the iterations. Gradient-based techniques, from the nonlinear optimization theory, may also be used with iterative algorithms. These include the quasi-Newton technique described in R. Fletcher and M. Powell, “A rapidly convergent descent method for minimization,” Comput. J., vol. 6, pp. 163-168, 1963 and the Gauss-Newton type Levenberg-Marquardt method described in D. Marquardt, “Algorithm for least-squares estimation of nonlinear parameters,” SIAM J. Appl. Math., vol. 11, pp. 431-441, 1963. The ML solution to the hyperbolic equations can be used due to the proven asymptotic consistency and efficiency of the ML estimator (MLE) which requires assumptions about the distribution of measurement errors as described in W. Hahn and S. Tretter, “Optimum processing for delay-vector estimation in passive signal arrays,” IEEE Trans. Inform. Theory, vol. 19, pp. 608-614, 1973, M. Wax, and T. Kailath, “Optimum localization of multiple sources by passive arrays,” IEEE Trans. Acoust., speech, Signal Process., vol. 31, no. 5, pp. 1210-1218, 1983, P. Stoica and A. Nehorai, “MUSIC, maximum likelihood and Cramer-Roa bound,” IEEE Trans. Acoust., Speech, Signal Process., vol. 37, pp. 720-740, 1989, J. Chen, R. Hudson, and K. Yao, “Maximum-likelihood source localization at unknown sensor location estimation for wideband signals in the near-field,” IEEE Trans. Signal Process., vol. 50, pp. 1843-1854, 2002, and Y. Huang, J. Benesty, and G. Elko, “Source Localization,” in Y. Huang and J. Benesty (Eds), “Audio signal processing for next-generation multimedia communication systems,” Kluwer Acad. Publ, Boston, Mass., pp. 229-253, 2004, the entire contents of each being herein incorporated by reference. In addition, the iterative algorithm to find the solution is computationally intensive.

The present disclosure relates to a position estimation method that receives time difference of arrival (TDOA) measurements from a plurality of stations; calculates, using processing circuitry, a nuisance parameter based on the TDOA measurements; refines, using the processing circuitry, a vertical position of the object based on at least the nuisance parameter; and sends the 3D position of the object to an external device to provide enhanced position data to host applications.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram that shows an object and four stations according to one example;

FIG. 2 is a schematic representation of the 3D position estimation system according to one example;

FIG. 3 is an exemplary block diagram illustrating the CFExSSLS/CFSSLS solution in the range domain according to one example;

FIG. 4 is an exemplary flow chart illustrating the CFExSSLS/CFSSLS method in the range domain according to one example;

FIG. 5 is an exemplary block diagram illustrating the CFExSSLS/CFSSLS solution in the solution domain according to one example;

FIG. 6 is an exemplary flow chart illustrating the CFExSSLS/CFSSLS method in the solution domain according to one example;

FIG. 7 is an exemplary block diagram illustrating the CFExSSLS/CFFSLS solution in the range domain according to one example;

FIG. 8 is an exemplary flow chart illustrating the CFExSSLS/CFFSLS method in the range domain according to one example;

FIG. 9 is an exemplary block diagram illustrating the CFExSSLS/CFFSLS solution in the solution domain according to one example;

FIG. 10 is an exemplary flow chart illustrating the CFExSSLS/CFFSLS method in the solution domain according to one example;

FIG. 11 is a flow chart illustrating a method to find the 3D position of the object using a hybrid process according to one example;

FIG. 12 is a table showing a list of stations according to one example; and

FIG. 13 is an exemplary block diagram of a server according to one example.

### DETAILED DESCRIPTION

Referring now to the drawings, wherein like reference numerals designate identical or corresponding parts throughout several views, the following description relates to a position estimation system and associated methodology for determining a 3D position of an object using hyperbolic equations. In selected embodiments, the method provides an improved vertical position estimation by using a nuisance parameter obtained from a hybrid process.

In order to overcome convergence problems, closed-form (CF) methods were developed. The nuisance parameter, which is the range from a receiver to a reference transmitter, is introduced to the set of the linearized equations. CF (analytical) solutions are desirable because they usually have less computational loads than iterative methods or maximum likelihood (ML) approaches such as described in Y. Chan and K. Ho, “A simple and efficient estimator for hyperbolic location,” IEEE Transactions on Signal Processing, vol. 42, no. 8, pp. 1905-1915, 1994 which is an approximation of the maximum likelihood estimator (MLE) (by a two-step weighted least-squares estimator (LSE)) where time difference of arrival (TDOA) measurement errors are assumed to be small. Furthermore, CF algorithms achieve estimation accuracies at acceptable levels, are mathematically simple, robust and easy to implement for practical real-time applications where low computational time and memory storage requirements are of high priority to meet imposed power constraints. Direct methods and closed-form least-squares algorithms have two major advantages: They do not need an initial position estimate to run, and they do not require any probabilistic assumptions about the distribution of the measurement errors and therefore can be employed when the precise characterization of measurement errors cannot be determined.

The total number of time difference of arrival (TDOA) measurements that can be generated using N available transmitters/sensors is N(N−1)/2 and is referred to as a full set (FS) measurements as described in H. So, Y. Chan, and F. Chan, “Closed-Form Formulae for Time-Difference-of-Arrival Estimation,” IEEE Transactions on Signal Processing, vol. 56, no. 6, pp. 2614-2620, 2008. When only measurements w.r.t. a single reference (or master) transmitter/sensor are considered, they are referred to as a single set (SS) measurements and their total number is N−1. When the SS and extra available measurements are used it is referred to as an extended SS (ExSS) measurements. The FS is described in R. Schmidt, “A new approach to geometry of range difference location,” IEEE Trans. Aerosp. Electron. Syst., vol. 8, no. 6, pp. 821-835, 1972 and R. Schmidt, “Least squares range difference location,” IEEE Trans. Aerosp, Electron. vol. 32, no. 1, pp. 234-242, 1996 each incorporated herein by reference.

A closed-form unconstrained and constrained LS solutions using a SS of the TDOA measurements as were described in P. Stoica and J. Li, “Source localization from range-difference measurements,” IEEE Signal Process. mag. Vol. 23, no. 11, pp. 63-65, November 2006 incorporated herein by reference. The solutions may be referred to as single-set least-squares (SSLS) solutions. Other closed-form SSLS solutions were described in J. Smith and J. Abel, “Closed-form least squares source location estimation from range difference measurements,” IEEE Trans. Acoustics, speech, Signal Processing, vol. 35, pp. 1661-1669, 1987 and Y. Huang, J. Benesty, G. Elko, and R. Mersereau, “Real-time passive source localization: A practical linear-correction least-squares approach,” IEEE Trans. Speech Audio Processing,” vol. 9, pp. 943-956, 2001 each incorporated herein by reference and are called the spherical interpolation (SI) and the linear-correction least squares (LCLS) respectively. Both the SI and LCLS methods requires range measurements which may not be available or may not be accurate enough due to clock synchronization errors, and are respectively equivalent to the unconstrained SSLS and constrained SSLS solutions which depends only on TDOA measurements. As correctly indicated by H. W. Wei and S. F. Ye,” Comments on “A linear closed-form Algorithm for Source Localization from Time-Difference of Arrival”,” IEEE signal Process. Lett., vol. 15, p. 895, 2008. The constrained SSLS solution described above was also described in M. Gillette and H. Silverman, “A linear closed-form algorithm for source localization from time-differences of arrival,” IEEE Signal Process. Lett., vol. 15, pp. 1-4, 2008 with corrections stated in B. Kim, “Comments on “A linear Closed-Form Algorithm for source Localization from Time-Difference of Arrival”,” IEEE signal Process. Lett., vol. 15, p. 900, 2008. The extension of the SSLS solution yielded an LS solution that utilizes two SS's of TDOA measurements made w.r.t. two reference transmitters, i.e. the total number of measurements equals 2(N−1).

A closed-form solution that depends on an ExSS of the TDOA measurements was presented in E. Bakhoum, “Closed-Form solution of Hyperbolic Geolocation Equations,” IEEE Trans. Aerospace and Electronic systems, vol. 42, no. 4, pp. 1396-1404, 2006 incorporated herein by reference in its entirety, in which a SS of TDOA measurements was used in addition to extra TDOA measurements made by the successive pairs of the rest transmitters/sensors. Thus, the number of used TDOA measurements equals (N−1)+(N−2). A direct solution to the TDOA nonlinear equations was given in A. Kleusberg, “Die direkte Lösung des räumlichen Hyperbelschnitts,” Zeitschrift fur Vermessungswesen, vol. 119, no. 4, pp. 188-192, 1994, where exactly four transmitters/sensors were required to utilize a SS of the TDOA measurements, i.e. three measurements. Other direct methods that also require exactly four transmitters/sensors can be found in R. Bucher and D. Misra, “A Synthesizable VHDL Model of the Exact Solution for Three-dimensional Hyperbolic Positioning System,” VLSI Design, vol. 15, no. 2, pp. 507-520, 2002 which uses a SS, i.e. three measurements, and one extra measurement from the FS and K. Yua, J. p. Montilleta, A. Rabbachina, P. Cheonga, and I. Oppermanna, “UWB Location and tracking for wireless embedded networks,” Signal Processing, vol. 86, pp. 2153-2171, 2006, where two SS's were used where one measurement is common to both SS's.

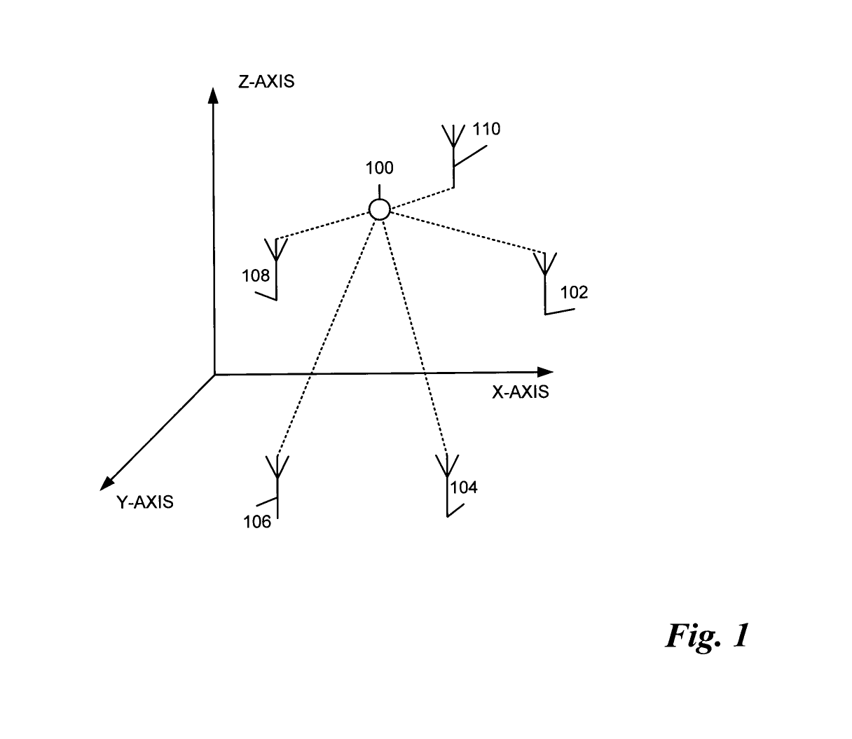

FIG. 1 is a schematic representation of a 3D position estimation system. The position of the object 100 is determined by the 3D position estimation system. As shown in FIG. 1, the system can be configured in a 3D rectangular coordinate system. The system consists of five stations 102,104,106,108,110 as shown in FIG. 1. Although five stations are shown in FIG. 1, five or more stations may be used by the system. The stations are arranged at different axis coordinates. The object 100 can comprise any object that can detect transmitted signals by the stations 102,104,106,108,110. In selected embodiments, the object 100 may be an aircraft, a missile, a satellite, a vehicle, or the like. In other embodiments, the object 100 may be any type of electronic device capable of detecting the transmitted signals by the stations 102,104,106,108,110. For example, the object 100 can be a cellular telephone, a paging device, a GPS receiver, a tablet, a smartphone or the like. Each of the five stations 102,104,106,108,110 is equipped with at least one transmitter. Each station can be equipped with many transmitters to transmit different types of signals.

The stations 102,104,106,108,110 may be pseudolites (pseudosatellittes), which are navigation (or global navigation satellite system (GNSS)-like) signal generators, and provide a rapid deployment and portable infrastructure for positioning, which can be seamlessly used in a locally limited area after an automatic self-calibration. The range of each transmitter signal may depend on the power available to the station. The stations 102,104,106,108,110 may be chosen depending on the application such as whether the operation is indoor or in harsh urban environments. The transmitted signals from the stations 102,104,106,108,110 are received by the object 100. The time of arrival of each of the transmitted signal is recorded.

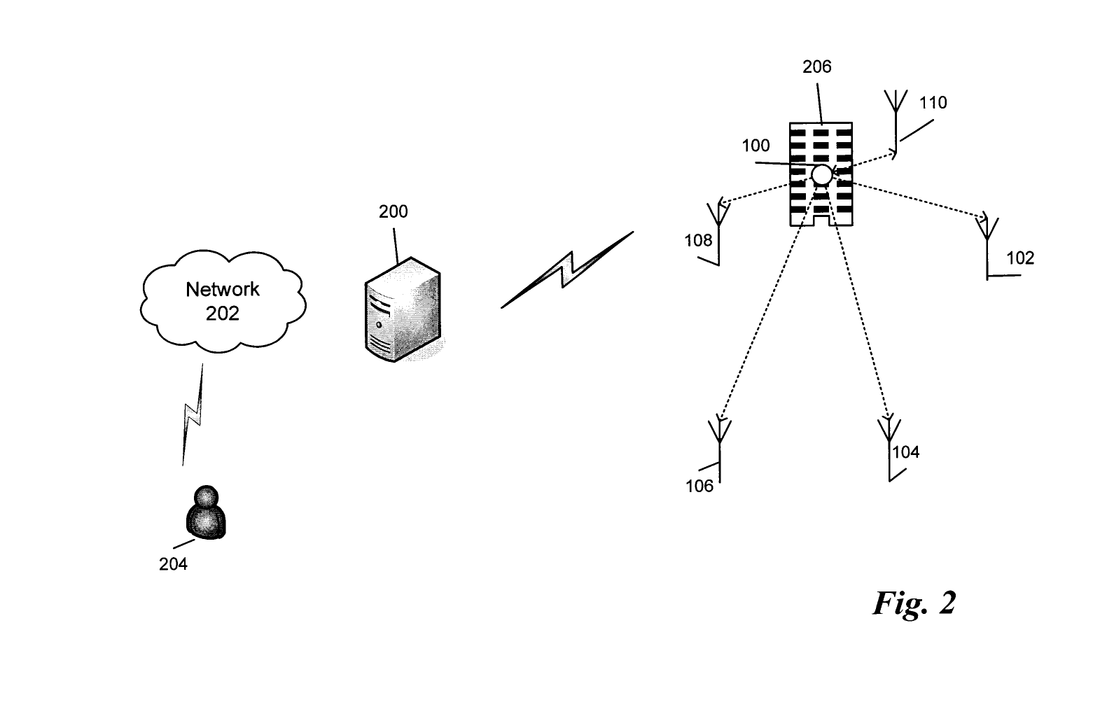

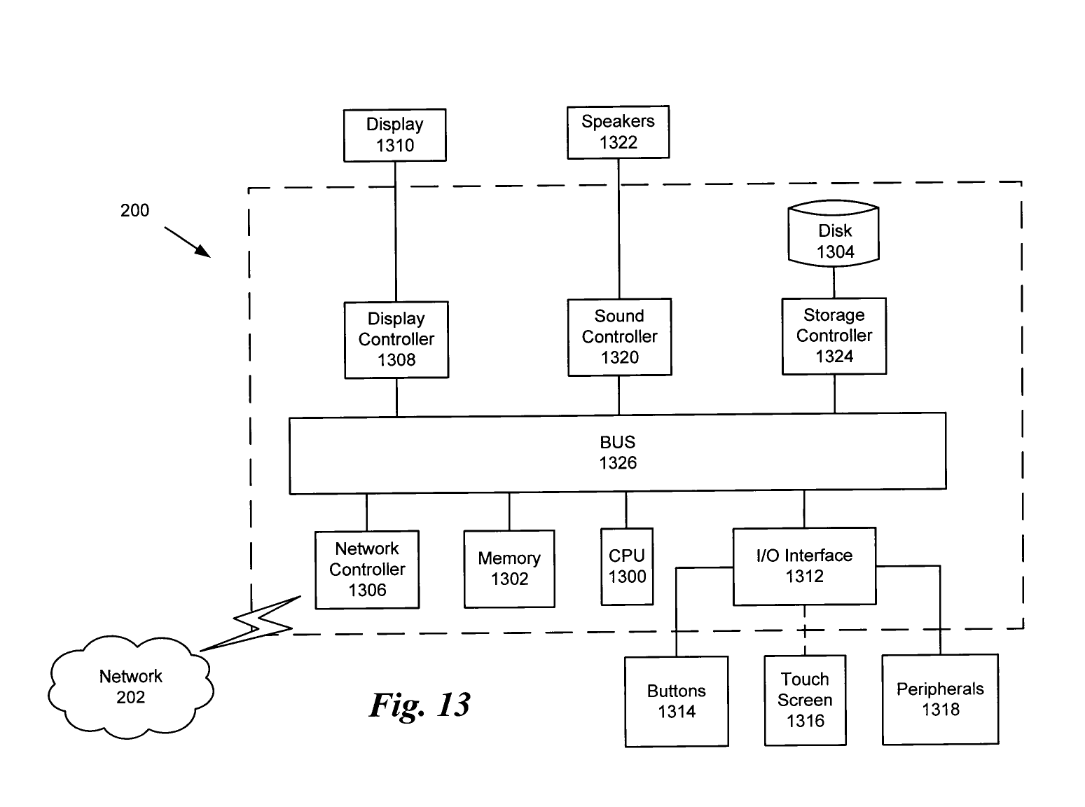

FIG. 2 is a schematic representation of the 3D position estimation system according to one example. The stations 102, 104, 106, 108, 110 may connect via communication circuitry to a server 200 to transmit and receive data. The stations 102, 104, 106, 108, 110 may transmit measurements to the server 200. The server 200 includes a CPU 1300 as shown in FIG. 13. A user 204 may connect via a network 202 to the server 200. The user 204 may send via the network 202 data such as information about the object that needs to be located. The network 202 is any network that allows the server 200 and the user 204 to communicate data with each other such as a Wide Area Network, Local Area Network or the Internet. The server 200 is one or more servers that respond to requests across a computer network and processes information. The user 204 is one or more users trying to locate the object 100. In other embodiments, the user may be a mobile device application or other software trying to locate the object 100. The object 100 may be part of a group of objects that needs to be located. The object 100 may be located indoor or outdoor. The object 100 may be located inside a building 206.

In other embodiments, the object 100 may be an emitter. Each of the stations 102, 104, 106, 108, 110 is equipped with at least one sensor. Each station may be equipped with many sensors to detect different types of objects. In selected embodiments, the sensor type can depend on the type of position determining system being employed. For example, the position determining system like radar, sonar, GPS, cellular and the like, each employ appropriate types of sensors to detect the relevant signals. In selected embodiments, the object location system may be contained at least in part in a spacecraft or aircraft such as MILSTAR satellite or JSTARS aircraft. A transmitted or reflected signal from the object 100 is received by each of the sensors at the stations 102, 104, 106, 108, 110. The time of arrival for the signal from the object 100 to each of the station is recorded. In selected embodiments, each station may include at least one transmitter and at least one sensor. Such stations can be used to locate the object of either type emitter or receiver.

Consider an array of N stations located at known positions aᵢ=[xᵢ,yᵢ,zᵢ]^{T}, in a 3D Cartesian coordinate system, where i=1, . . . , N and ^{T} is the transpose operator, and the object 100, at an unknown position aᵣ=[xᵣ,yᵣ,zᵣ]^{T}, observing signals radiating from the stations. As described above, each station may include at least one transmitter and/or at least one receiver. The object 100 measures the TDOA of a pair of signals radiated by any pair of stations i and j, where i≠j. The TDOA measurement (r related to a range difference (dᵢⱼ) by the relation dᵢⱼ=c·τᵢⱼ, where c is the known propagation speed of the signal in the medium. Thus, dᵢⱼ may be expressed in the error free case as

dᵢⱼ=∥aⱼ−aᵣ∥−∥aᵢ−aᵣ∥ (1)

where i=1, . . . N, j=1, . . . N, i≠j and ∥•∥ denotes the Euclidean vector norm. The problem, thus, is to estimate the vector aᵣ given a set of dᵢⱼ, i.e. τᵢⱼ, noisy measurements and using the known vectors aᵢ, which in turn might contain uncertainties.

The Closed-Form Single-Set Least-Squares (CFSSLS) solution is described next. The LSE minimizes a squared error function called the cost function. In the absence of measurement errors and station position uncertainties, the LSE minimization may yield a zero cost function. Equation (1) can be rewritten as

∥aⱼ−aᵣ∥²=[dᵢⱼ+∥aᵢ−aᵣ∥]² (2)

Equation (2) can be rewritten after straightforward algebra as

$${d}_{ij} ‖ {a}_{i} - {a}_{r} ‖ + {[ {a}_{j} - {a}_{i} ]}^{T} \cdot {a}_{r} = \frac{{‖ {a}_{j} ‖}^{2} - {‖ {a}_{i} ‖}^{2} - {d}_{ij}^{2}}{2} \qquad ( 3 )$$

In one embodiment, without loss of generality, the first station 102 may be considered as the reference station, and thus equation (3) may be rewritten as

d₁ⱼ∥a₁−aᵣ∥+[aⱼ−aᵢ]^{T}·aᵣ=b₁ⱼ (4)

where b₁ⱼ=|∥aⱼ∥²−∥a₁∥²−d₁ⱼ²|/2 and j=2, . . . N. The cost function ƒ_{c} to be minimized by the LSE may be written as

$${f}_{c} = {\sum }_{j = 2}^{N} {( {d}_{1 j} ‖ {a}_{1} - {a}_{r} ‖ + {[ {a}_{j} - {a}_{1} ]}^{T} \cdot {a}_{r} - {b}_{1 j} )}^{2} \qquad ( 5 )$$

Equation (4) can be expressed in matrix form as

$$Hs = b \\ where \\ H = [ \begin{matrix}{d}_{12} & {[ {a}_{2} - {a}_{1} ]}^{T} \\ {d}_{13} & {[ {a}_{3} - {a}_{1} ]}^{T} \\ ⋮ & ⋮ \\ ⋮ & ⋮ \\ {d}_{1 N} & {[ {a}_{N} - {a}_{1} ]}^{T}\end{matrix} ] , b = [ \begin{matrix}{b}_{12} \\ {b}_{13} \\ ⋮ \\ ⋮ \\ {b}_{1 N}\end{matrix} ] , s = [ \begin{matrix}‖ {a}_{1} - {a}_{r} ‖ \\ {a}_{r}\end{matrix} ] . \qquad ( 6 )$$

Note that H is an (N−1)×4 matrix, b is an (N−1)×1 vector and s is a 4×1 vector where the range ∥a₁−aᵣ∥ to the reference station is the nuisance parameter. For example, the nuisance parameter may be the distance between the target to the master beacon. The cost function of equation (5) can thus be rewritten using the matrix notation as

ƒ_{c}=∥Hₛ−b∥² (7)

The unconstrained CFSSLS solution of s may be expressed as

\hat{s}=(H^{T}H)⁻¹H^{T}b (8)

and the corresponding estimate of aᵣ is given as

â=[ŝ(2)\hat{s}(3)\hat{s}(4)] (9)

Four or more independent TDOA measurements w.r.t a common reference station can be used to estimate the 4×1 vector s. Five or more stations can be used in order to obtain a 3D closed form solution, i.e. Nₘᵢₙ=5.

Next, the Closed form extended single set least squares (CFExSSLS) solution is described. In one embodiment, five stations may be used. The hyperbolic equations are transformed into a set of vector equations by squaring the set of equations given by equation (1) and then subtracting them. The solution uses a SS of the TDOA measurements in addition to extra TDOA measurements made by the successive pairs of the rest of the stations, i.e. for N=5, the following (N−1)+(N−2)=7 measurements are used: d₂₁,d₃₁,d₄₁,d₅₁,d₃₂,d₄₃,d₅₄. In other embodiments, more than five stations may be used. For an arbitrary number of stations, i.e. N≧5, the simultaneous equations may be expressed in algebraic form as

$$\begin{matrix}{a}_{11} \cdot {x}_{r} + {a}_{12} \cdot {y}_{r} + {a}_{13} \cdot {z}_{r} = {b}_{1} \\ {a}_{21} \cdot {x}_{r} + {a}_{22} \cdot {y}_{r} + {a}_{23} \cdot {z}_{r} = {b}_{2} \\ … \\ … \\ {a}_{( N - 2 ) 1} \cdot {x}_{r} + {a}_{( N - 2 ) 2} \cdot {y}_{r} + {a}_{( N - 2 ) 3} \cdot {z}_{r} = {b}_{N - 2}\end{matrix} \\ where \\ {a}_{11} = \frac{2}{{d}_{21}} ( {x}_{2} - {x}_{1} ) - \frac{2}{{d}_{31}} ( {x}_{3} - {x}_{1} ) \\ {a}_{12} = \frac{2}{{d}_{21}} ( {y}_{2} - {y}_{1} ) - \frac{2}{{d}_{31}} ( {y}_{3} - {y}_{1} ) \\ {a}_{13} = \frac{2}{{d}_{21}} ( {z}_{2} - {z}_{1} ) - \frac{2}{{d}_{31}} ( {z}_{3} - {z}_{1} ) \\ {b}_{1} = \frac{1}{{d}_{21}} ( {x}_{2}^{2} + {y}_{2}^{2} + {z}_{2}^{2} - {x}_{1}^{2} + {y}_{1}^{2} + {z}_{1}^{2} ) - \frac{1}{{d}_{31}} ( {x}_{3}^{2} + {y}_{3}^{2} + {z}_{3}^{2} - {x}_{1}^{2} + {y}_{1}^{2} + {z}_{1}^{2} ) + {d}_{32} . \qquad ( 10 )$$

The other constants in equation (10) can be similarly written. The set of equations in (10) also can be put in the matrix form Hs=b, where

$$H = [ \begin{matrix}{a}_{11} & {a}_{12} & {a}_{13} \\ {a}_{21} & {a}_{22} & {a}_{23} \\ ⋮ & ⋮ & ⋮ \\ ⋮ & ⋮ & ⋮ \\ {a}_{( N - 2 ) 1} & {a}_{( N - 2 ) 2} & {a}_{( N - 2 ) 3}\end{matrix} ] , b = [ \begin{matrix}{b}_{1} \\ {b}_{2} \\ ⋮ \\ ⋮ \\ {b}_{N - 2}\end{matrix} ] , s = {a}_{r} .$$

H is an (N−2)×3 matrix, b is an (N−2)×1 vector and s is a 3×1 vector. The unconstrained CFExSSLS solution may be expressed as

âᵣ=(H^{T}H)⁻¹H^{T}b (11)

Note that only the unknown position vector of the object is estimated without any nuisance parameters.

The CFExSSLS solution has no nuisance parameters as explained above. Therefore, an accuracy improvement of the object's vertical position cannot be achieved without further external inputs. The accuracy improvement of the object's vertical position may be needed when the stations are coplanar as described in M. Khalaf-Allah, “Hybridization of Closed-Form Time-Difference-of-Arrival Positioning Algorithms”, NNGT Journal: International Journal of Signal Processing and Imaging Engineering, Vol. 1, 2014, incorporated herein by reference in its entirety. One method is to utilize the nuisance parameter obtained from the CFSSLS solution. The resulting algorithm is a hybrid solution and is denoted as CFExSSLS/CFSSLS algorithm. The hybrid algorithm is specifically useful when for example the CFExSSLS estimates of the object's horizontal position are more accurate than the CFSSLS estimates.

The object 100 vertical position may be refined by using the 2D solution of the CFExSSLS. The approach is known as CFExSSLS/CFSSLS in the range domain (RD). In other embodiments, the object 100 vertical position may be refined using the 2D solution of the second half of the CFExSSLS/CFSSLS algorithm. The resulting approach is known as CFExSSLS/CFSSLS in the solution domain (SD).

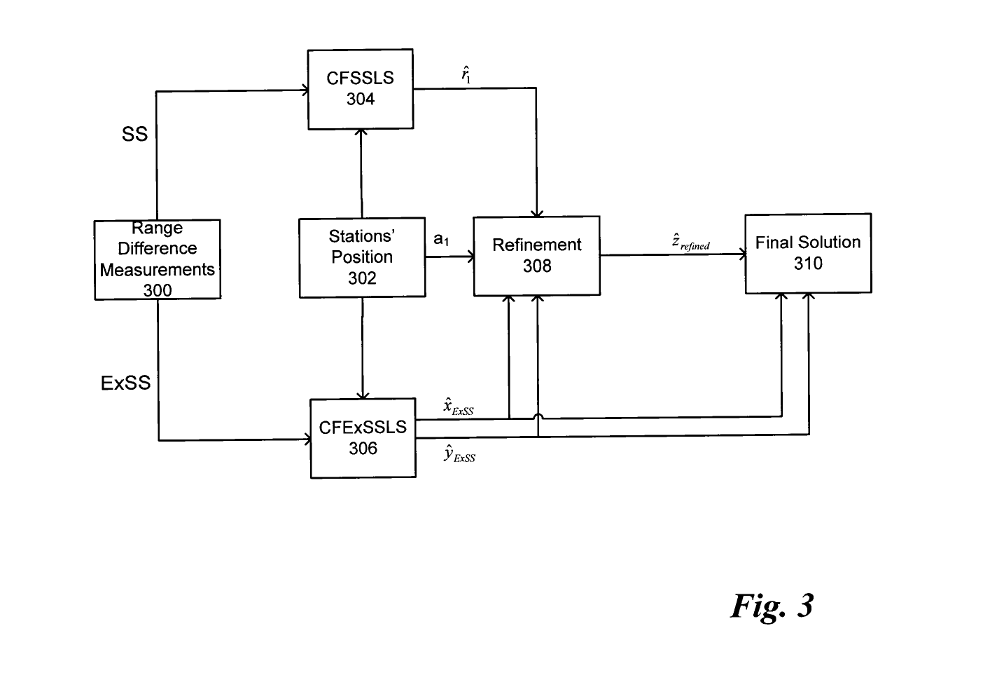

FIG. 3 is an exemplary block diagram illustrating the CFExSSLS/CFSSLS solution in the range domain according to one example. A range difference measurements module 300 may calculate the TDOA of signal transmitted or received between the stations 104,106,108,110 and the reference station 102. Each of the modules described herein may be implemented in circuitry that is programmable (e.g. microprocessor-based circuits) or dedicated circuits such as application specific integrated circuits (ASICS) or field programmable gate arrays (FPGAS). The output from the range difference measurements module 300 is fed to a CFSSLS module 304 and to a CFExSSLS module 306. A stations' position module 302 stores the position of available stations. The stations' position module 302 outputs the required stations position to the CFSSLS module 304 and the CFExSSLS module 306. The stations' positions module 302 outputs the position of the reference station to a refinement module 308. The CFSSLS module 304 computes the range to the reference station. The reference station may be chosen as station 102. In selected embodiments, the reference station may be chosen as the station with the most accurate known position. For example, in cases when one station position is fixed. The CFSSLS module 304 outputs the range to the refinement module 308. The CFExSSLS module 306 computes the horizontal coordinates of the object 100 using the CFExSSLS solution described above. The refinement module 308 takes the range to the reference station, the required stations' position, and the horizontal coordinates and computes the vertical position of the object 100. The final solution module 310 receives the refined vertical position, and the horizontal coordinates and outputs the 3D position of the object 100 to host applications.

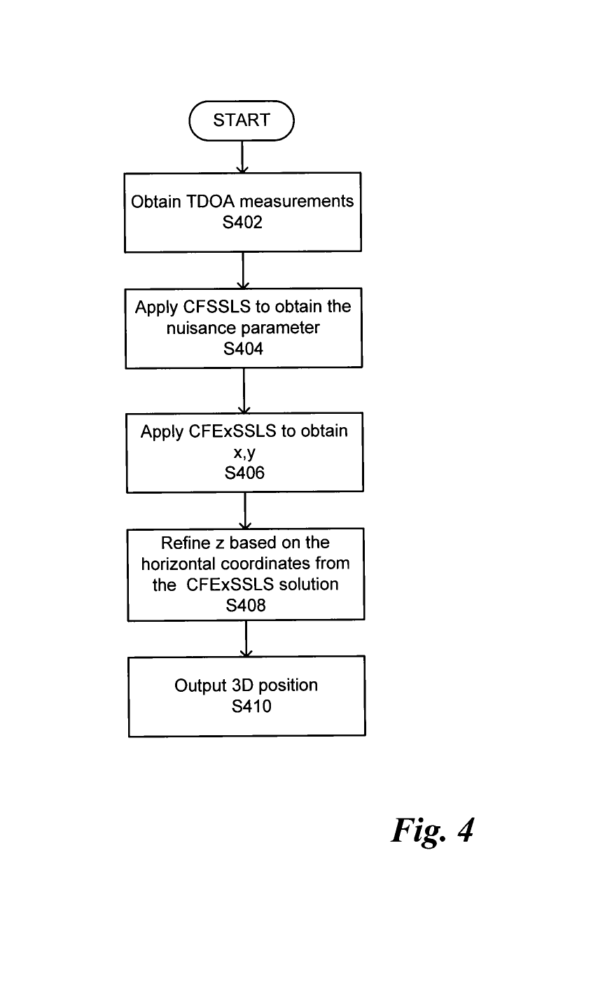

FIG. 4 is an exemplary flow chart illustrating the CFExSSLS/CFSSLS method in the range domain according to one example. At step S402, the TDOA measurements from the object 100 are received by the server 200. At step S404, the nuisance parameter (range to the reference station) may be calculated using equation (9) of the CFSSLS solution described above. At step S406, the horizontal position of the object 100 are calculated in the CFExSSLS module 306. At step S408, the vertical position z of the object 100 is refined. The vertical position refinement method may be that disclosed in U.S. patent application Ser. No. 13/856,415 entitled “METHOD TO OBTAIN ACCURATE VERTICAL COMPONENT ESTIMATES IN 3D POSITIONING”, the entire disclosure of which is incorporated herein by reference. The 2D solution from the CFExSSLS (\hat{x}_{ExSS}, ŷ_{ExSS}) obtained at step S406, the estimated range to the reference station \hat{r}ᵢ, or ∥a₁−aᵣ∥, and its known position a₁ are employed. The resulting refined vertical position estimate \hat{z}_{refined} is then combined with the CFExSSLS 2D estimate (\hat{x}_{ExSS}, ŷ_{ExSS}) to give the final 3D position solution, at step S410.

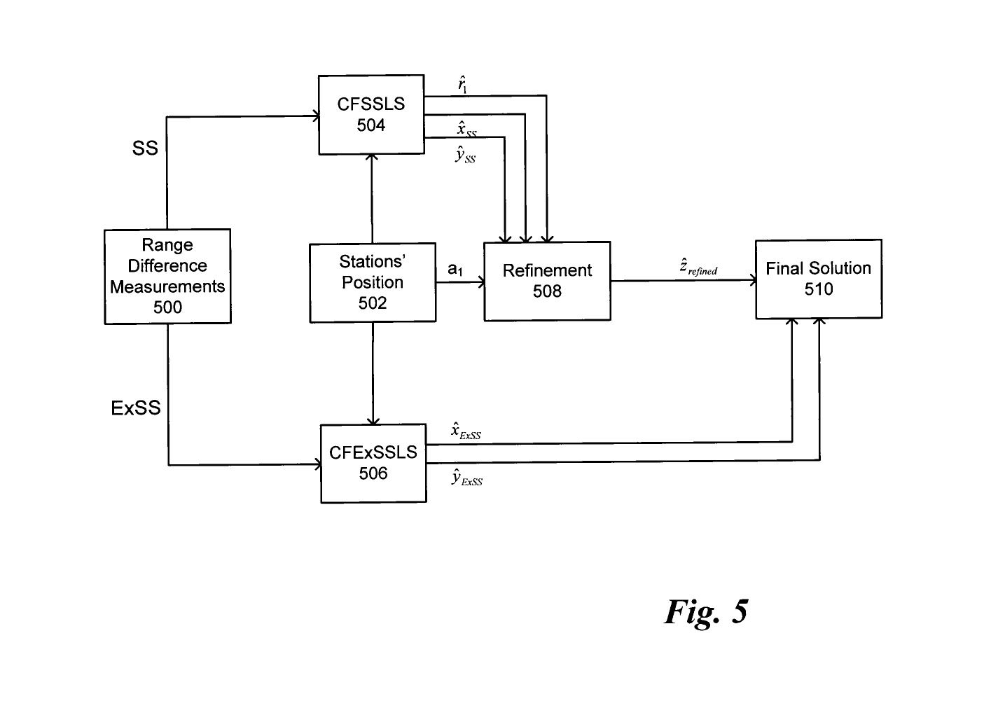

FIG. 5 is an exemplary block diagram illustrating the CFExSSLS/CFSSLS solution in the solution domain according to one example. A range difference measurements module 500 may calculate the TDOA of signal transmitted or received between the stations 104,106,108,110 and the reference station 102. The output from the range difference measurements module 500 is fed to a CFSSLS module 504 and a CFExSSLS module 506. A stations' position module 502 stores the position of the stations. The stations' position module 502 outputs the required stations position to the CFSSLS module 504 and to the CFExSSLS module 506. The stations' position module 502 outputs the reference station position to a refinement module 508. The CFSSLS module 504 computes the range to the reference station and the CFSSLS horizontal coordinates of the object 100. The CFSSLS module 504 outputs the range and the CFSSLS horizontal coordinates to the refinement module 508. The refinement module 508 takes the range to the reference station, the required stations position, and the CFSSLS horizontal coordinates and computes the vertical position of the object 100. The CFExSSLS module 506 computes the horizontal coordinates of the object 100. The final solution module 510 receives the refined vertical position from the refinement module 508, and the horizontal coordinates from the CFExSSLS 506 module and outputs the 3D position of the object 100 to host applications.

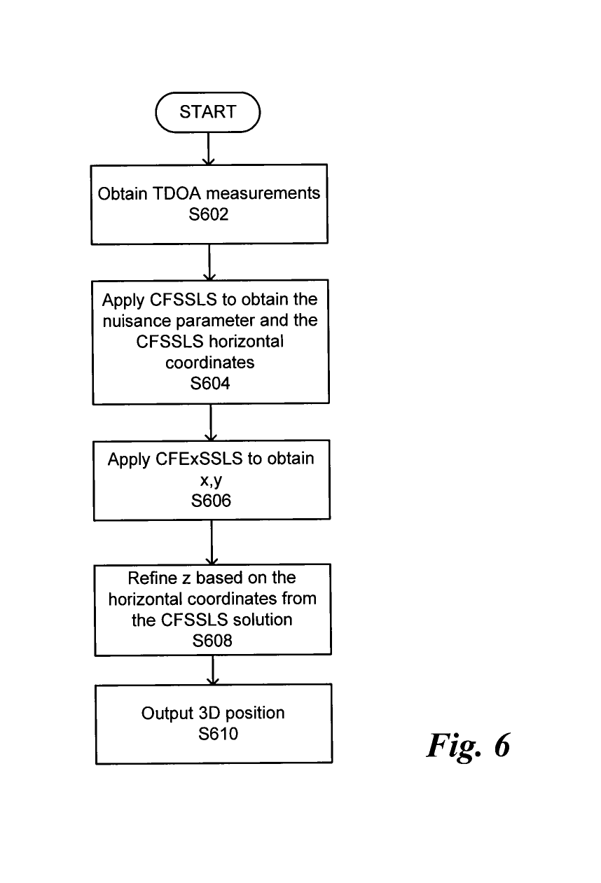

FIG. 6 is an exemplary flow chart illustrating the CFExSSLS/CFSSLS method in the solution domain according to one example. At step S602, the TDOA measurements from the object 100 are received by the server 200. At step S604, the nuisance parameter (range to the reference station) may be calculated from the CFSSLS solution equation (9). The CFSSLS horizontal coordinates may be calculated using the CFSSLS solution described above. At step S606, the horizontal position of the object 100 are calculated in the CFExSSLS module 406. At step S608, the vertical position z of the object 100 is refined using the nuisance parameter and the CFSSLS horizontal coordinates. At step S610, the final 3D position of the object is obtained by combining the 2D estimate of the CFExSSLS (x̅_{ExSS}, ŷ_{ExSS}) with the vertical position refinement \hat{z}_{refined}, done by the CFSSLS solution only, hence the attribute solution domain of this hybrid algorithm.

The closed form full set least squares (CFFSLS) solution is described next. The set of measurement equations in the SS case are given in equation (4). Accordingly, the set of measurement equations in the FS case can be written as

$$\begin{matrix}{d}_{1 j} ‖ {a}_{1} - {a}_{r} ‖ + {[ {a}_{j} - {a}_{1} ]}^{T} \cdot {a}_{r} = {b}_{1 j} , j = 2 , … N \\ {d}_{2 j} ‖ {a}_{2} - {a}_{r} ‖ + {[ {a}_{j} - {a}_{2} ]}^{T} \cdot {a}_{r} = {b}_{2 j} , j = 3 , … N \\ ⋮ \\ ⋮ \\ {d}_{N - 1 , N} ‖ {a}_{N - 1} - {a}_{r} ‖ + {[ {a}_{N} - {a}_{N - 1} ]}^{T} \cdot {a}_{r} = {b}_{N - 1 , N}\end{matrix} \qquad ( 12 )$$

In one embodiment, the first, second, and (N−1)^{th} stations may be considered sequentially as reference stations, and the range difference measurements dᵢⱼ=−dⱼᵢ were considered only once. Equation (12) can also be written in matrix form as in equation (6) where

$$H = [ \begin{matrix}{d}_{12} & 0 & 0 & … & … & {[ {a}_{2} - {a}_{1} ]}^{T} \\ {d}_{13} & 0 & 0 & … & … & {[ {a}_{3} - {a}_{1} ]}^{T} \\ ⋮ & … & … & … & … & ⋮ \\ ⋮ & … & … & … & … & ⋮ \\ {d}_{1 N} & 0 & 0 & … & … & {[ {a}_{N} - {a}_{1} ]}^{T} \\ 0 & {d}_{23} & 0 & … & … & {[ {a}_{3} - {a}_{2} ]}^{T} \\ 0 & {d}_{24} & 0 & … & … & {[ {a}_{4} - {a}_{2} ]}^{T} \\ ⋮ & … & … & … & … & ⋮ \\ ⋮ & … & … & … & … & ⋮ \\ 0 & {d}_{2 N} & 0 & … & … & {[ {a}_{N} - {a}_{2} ]}^{T} \\ ⋮ & … & … & … & … & ⋮ \\ ⋮ & … & … & … & … & ⋮ \\ ⋮ & … & … & … & … & ⋮ \\ 0 & … & … & 0 & {d}_{N - 1 , N} & {[ {a}_{N} - {a}_{N - 1} ]}^{T}\end{matrix} ] , \\ b = [ \begin{matrix}{b}_{12} \\ {b}_{13} \\ ⋮ \\ ⋮ \\ {b}_{1 N} \\ {b}_{23} \\ {b}_{24} \\ ⋮ \\ ⋮ \\ {b}_{2 N} \\ ⋮ \\ ⋮ \\ ⋮ \\ {b}_{N - 1 , N}\end{matrix} ] s = [ \begin{matrix}‖ {a}_{1} - {a}_{r} ‖ \\ ‖ {a}_{2} - {a}_{r} ‖ \\ ⋮ \\ ⋮ \\ ‖ {a}_{N - 1} - {a}_{r} ‖ \\ {a}_{r}\end{matrix} ] .$$

The matrix H has a dimension of

$$\frac{N ( N - 1 )}{2} \cdot ( N + 2 ) , b is an \frac{N ( N - 1 )}{2} \times 1$$

vector and s is an (N+2)×1 vector. The matrix notation of the cost function to be minimized by the LSE and the unconstrained CFFSLS solution of s also are written as in equations (8) and (9) respectively. The estimate of aᵣ may be expressed as

âᵣ=[ŝ(n)\hat{s}(n+1)\hat{s}(n+2)] (13)

Note the number of nuisance parameters in the (N+2)×1 vector s given has increased to N−1 parameters, i.e. ∥aᵢ−aᵣ∥, to all stations that acted as references stations, where i=1, . . . N−1.

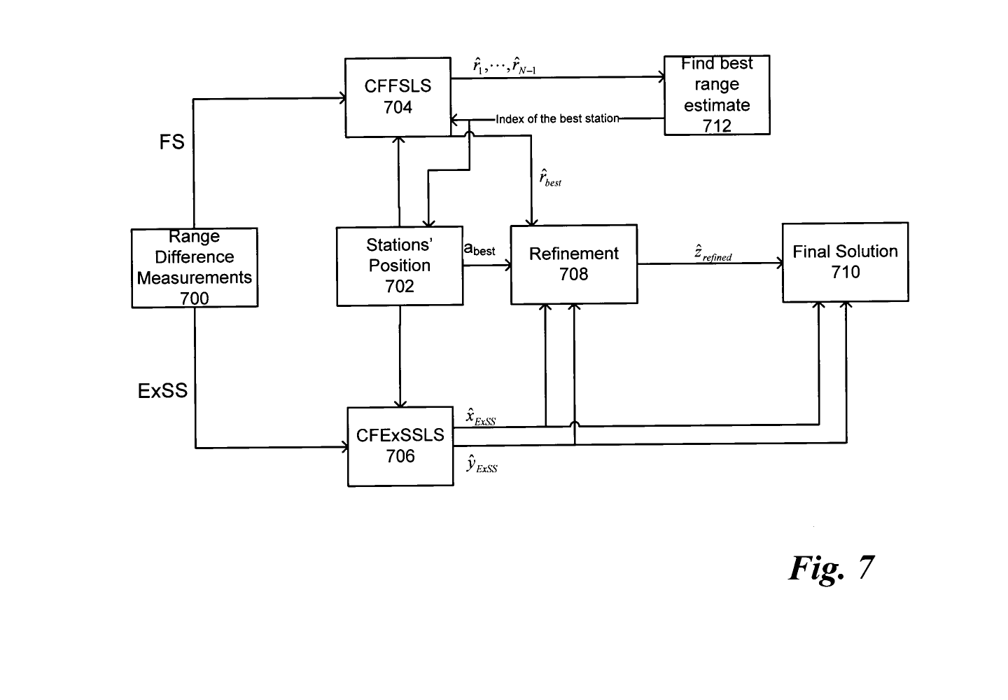

FIG. 7 is an exemplary block diagram illustrating the CFExSSLS/CFFSLS solution in the range domain according to one example. A range difference measurements module 700 calculates the TDOA of a pair of signal transmitted by any two of the stations 102,104,106,108,110. The output from the range difference measurements module 700 is fed to a CFFSLS module 704 and to a CFExSSLS module 706. Each of the modules described herein may be implemented in circuitry that is programmable (e.g. microprocessor-based circuits) or dedicated circuits such as application specific integrated circuits (ASICS). A stations' position module 702 stores the position of available stations. The stations' position module 702 outputs the required stations' position to the CFFSLS module 704 and the CFExSSLS module 706. The CFFSLS module 704 outputs ranges to all stations to a best range estimator module 712. The best range estimator module 712 may find an index to the station to be used. The method for choosing the index of the best station may be that disclosed in U.S. patent application Ser. No. 13/856,415 entitled METHOD TO OBTAIN ACCURATE VERTICAL COMPONENT ESTIMATES IN 3D POSITIONING, the entire disclosure of which is incorporated herein by reference. The best range estimator module 712 outputs the index to the best station to the CFFSLS module 704 and to the stations position module 702. The CFSSLS module 704 outputs the range of the station with the index obtained from the best range estimator module 712 to the refinement module 708. The CFExSSLS module 706 computes the horizontal coordinates of the object 100. The refinement module 708 takes the range to the reference station, the required position of the station given by the index, and the horizontal coordinates and computes the vertical position of the object 100. The final solution module 710 receives the refined vertical position, and the horizontal coordinates and outputs the 3D position of the object 100 to the host applications.

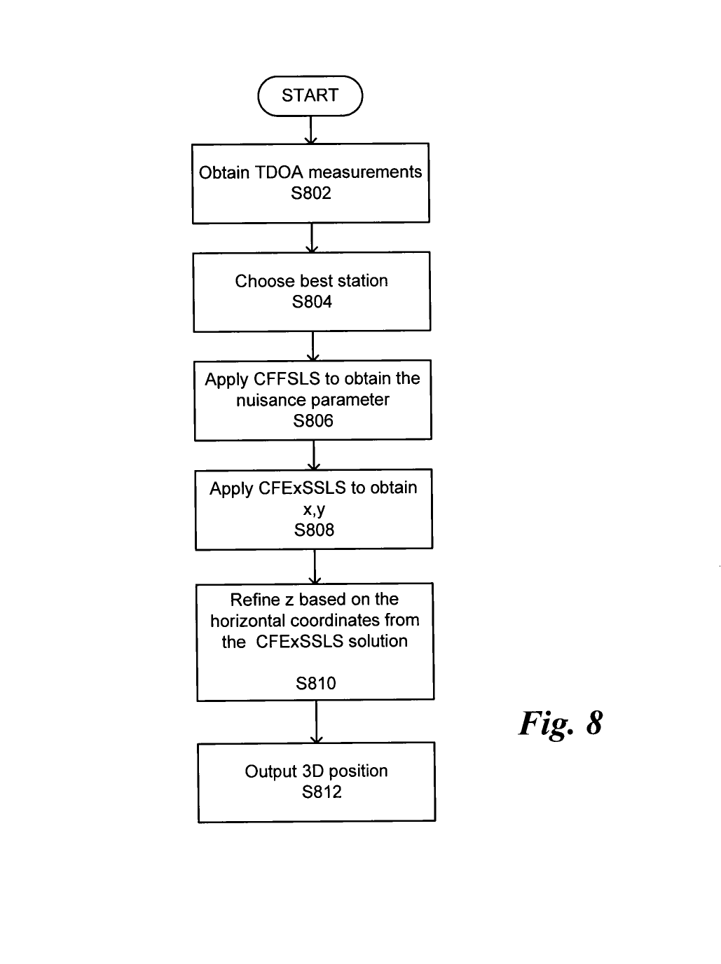

FIG. 8 is an exemplary flow chart illustrating the CFExSSLS/CFFSLS method in the range domain according to one example. In the CFExSSLS/CFFSLS method the nuisance parameters are the only contribution of the CFFSLS solution. At step S802, the TDOA measurements from the object 100 are received by the server 200. At step S804, a best station is chosen as described above. The best station may be the station that gives the most accurate range estimate from the N−1 estimates available. At step S806, the nuisance parameter (range to the reference station) may be calculated using equation (13) from the CFFSLS solution. At step S808, the horizontal position of the object 100 are calculated in the CFExSSLS module 706. At step S810, the vertical position z of the object 100 is refined. The horizontal coordinates (\hat{x}_{ExSS}, ŷ_{ExSS}) from the CFExSSLS solution are obtained at step S808. The estimated range to the best station \hat{r}_{best}, or ∥a_{best}−aᵣ∥, and its known position a_{best} are employed to calculate the horizontal coordinates. The resulting refined vertical position estimate \hat{z}_{refined} is then combined with the CFExSSLS 2D estimate (\hat{x}_{ExSS}, ŷ_{ExSS}) to give the final 3D position solution, at step S812.

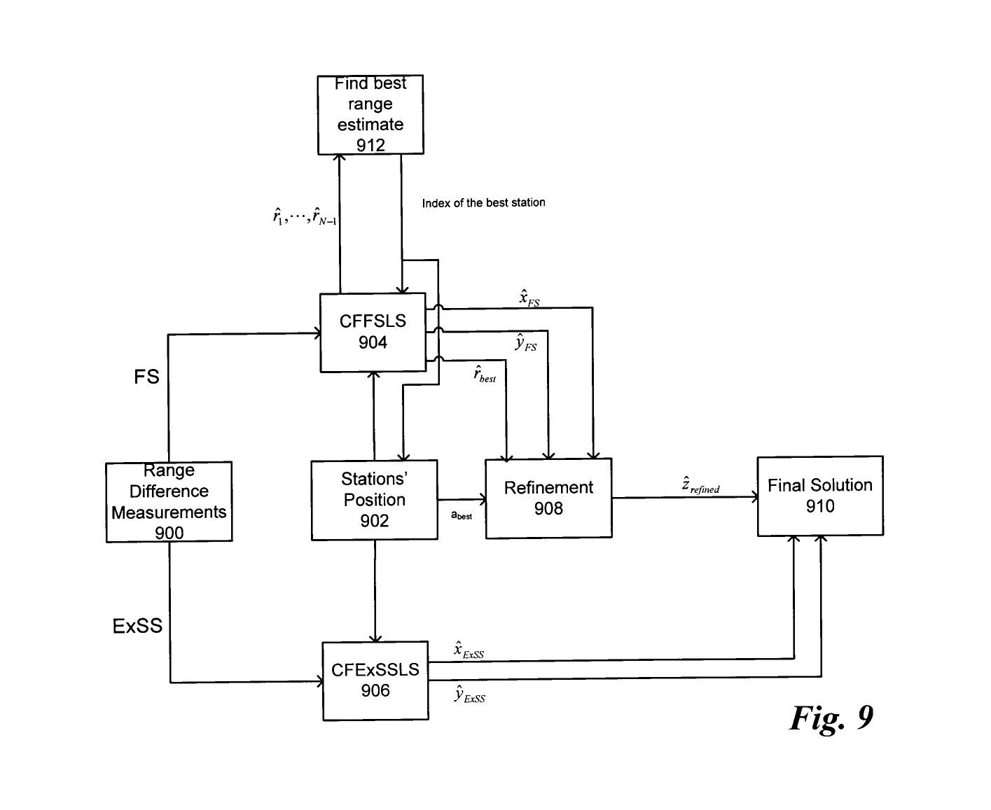

FIG. 9 is an exemplary block diagram illustrating the CFExSSLS/CFFSLS solution in the solution domain according to one example. A range difference measurements module 900 calculates the TDOA of a pair of signals transmitted by any two of the stations 102,104,106,108,110. The output from the range difference measurements module 900 is fed to a CFFSLS module 904 and to a CFExSSLS module 906. A stations' position module 902 stores the position of available stations. The stations' position module 902 outputs the required stations position to the CFFSLS module 904 and to the CFExSSLS module 906. The CFSSLS module 904 outputs ranges to all stations to a best range estimator module 912. The best range estimator module 912 may find an index to the station to be used. The best range estimator module 912 outputs the index of the station to be used to the CFFSLS module 904 and to the stations' position module 902. The CFFSLS module 904 outputs the range of the station with the chosen index and the CFFSLS horizontal coordinates to the refinement module 908. The refinement module 908 takes the range to the reference station, the required stations' position, and the CFFSLS horizontal coordinates and computes the vertical position of the object 100. The CFExSSLS module 906 computes the horizontal coordinates of the object 100. The final solution module 910 receives the refined vertical position from the refinement module 908, and the horizontal coordinates from the CFExSSLS module 906 and outputs the 3D position of the object 100 to the host applications.

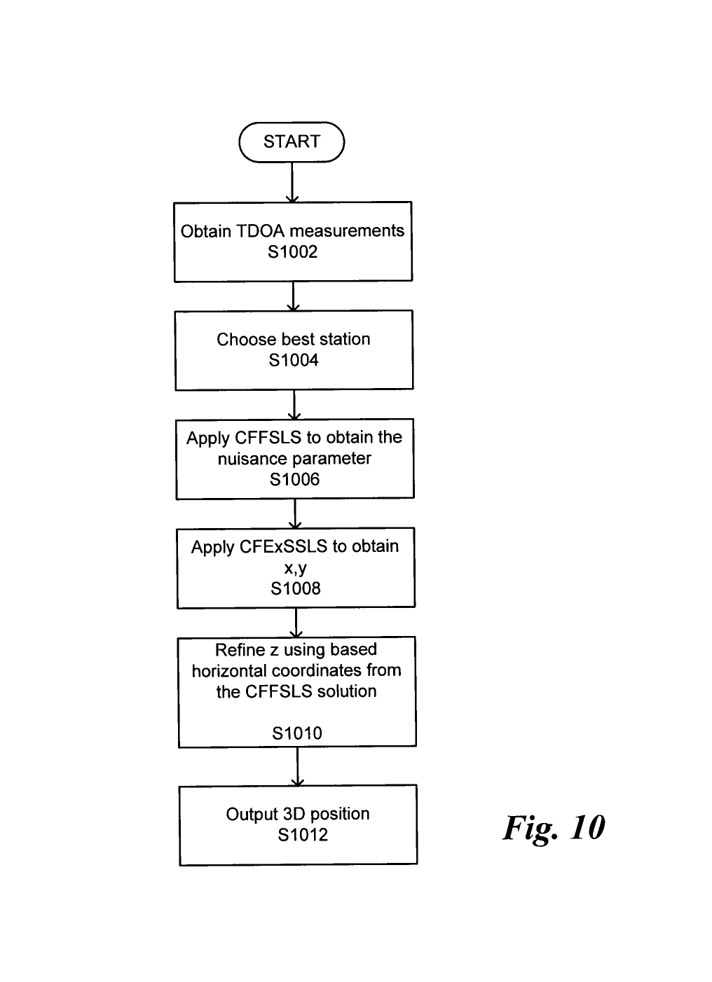

FIG. 10 is an exemplary flow chart illustrating the CFExSSLS/CFFSLS method in the solution domain according to one example. At step S1002, the TDOA measurements from the object 100 are received by the server 200. At step S1004, the best station is chosen as described above. The best station may be the station that gives the most accurate range estimate from the N−1 estimates available. At step S1006, the nuisance parameter (range to the reference station) may be calculated from the CFFSLS method equation (13). At step S1008, the horizontal position of the object 100 are calculated in the CFExSSLS module 906. At step S1010, the vertical position z of the object 100 is refined. The resulting refined vertical position estimate \hat{z}_{refined} is then combined with the CFExSSLS 2D estimate (\hat{x}_{ExSS}, ŷ_{ExSS}) to give the final 3D position solution, at step S1012.

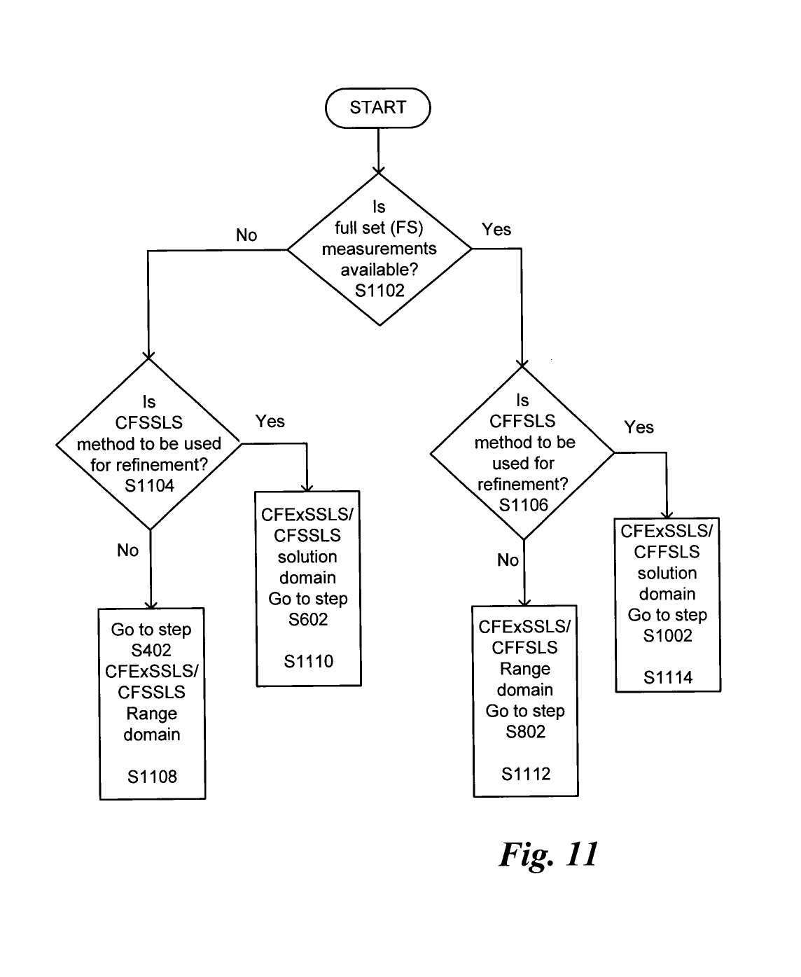

FIG. 11 is a flow chart illustrating a method to find the 3D position of the object using a hybrid process according to one example. At step S1102, the CPU 1300 may check whether the full set (FS) measurement is available. The FS may be stored in the server 200. In response to determining that the FS is available, the flow goes to S1106. In response to determining that the FS is not available, the flow goes to S1104. At S1104, the CPU 1300 may choose whether the horizontal coordinates from the CFSSLS solution are to be used for the vertical position refinement. The CPU 1300 may use historical data in a given area to choose whether using the CFSSLS horizontal coordinates yield more accurate results. In response to determining that the horizontal coordinates from the CFSSLS solution are to be used, the flow goes to step S1110. At step S1110, the flow continues from S602. In response to determining that the CFSSLS horizontal coordinates are not to be used for the vertical component, then the flow goes to S1108. At S1108, the flow continues from S402. At S1106, the CPU may analyze whether the CFFSLS horizontal coordinates are to be used in the vertical component refinement. The analysis may include comparison of past data from both solutions in a given area to decide which may give better results. In response to determining that the CFFSLS horizontal coordinates are to be used, then the flow goes to S1114. At S1114, the flow continues using the CFExSSLS/CFFSL in the solution domain from step S1002. In response to determining that the CFFSLS horizontal coordinates are not to be used, then the flow goes to S1112. At step S1112, the flow continues from step S802.

In other embodiments, the solution to be used may be indicated by the user 204. The user 204 may indicate to the server 200, via the network 202, the solution to be used. In other embodiments, the CPU 1300 may select the solution to be used based on an accuracy level needed by the host application requesting the object location.

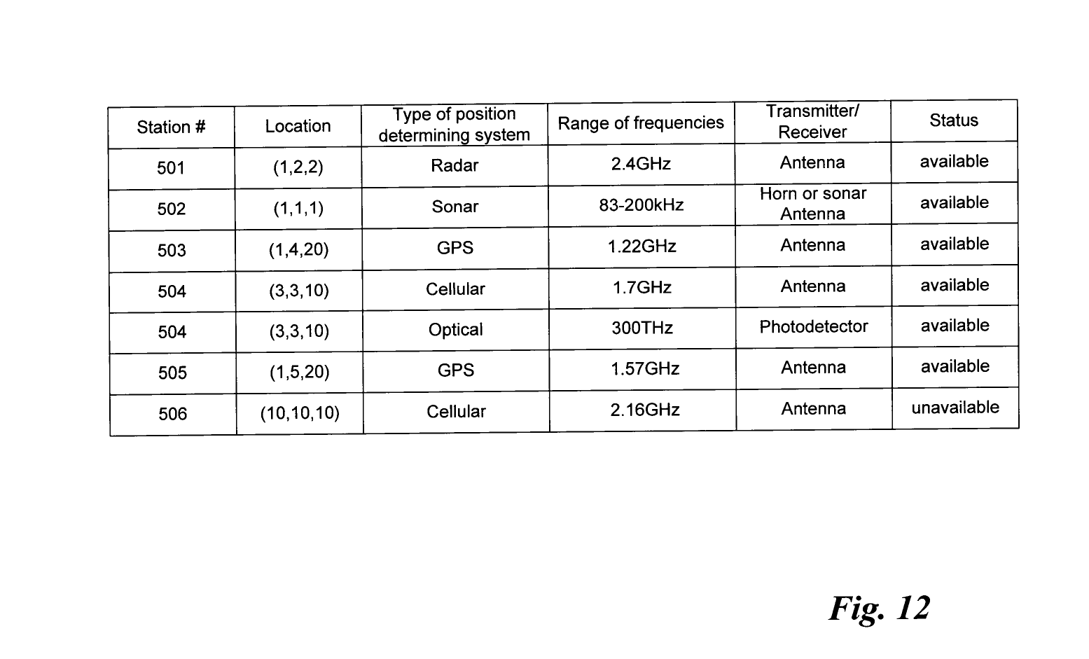

FIG. 12 is a table showing a list of stations according to one example. In selected embodiments, the table contains a station identification number, a station location, a type of position determining system, a range of frequencies, a transmitter type, a receiver type, and a status. For example, the table shows that station 501 uses a radar based position system with a frequency of 2.4 GHz and the sensor type is an antenna. The CPU 1300 may use the table that lists the type of sensors and/or transmitters available in each station to select the stations to be used to localize the object 100. This involves identifying the set of at least five stations. The table may be stored in the server 200. In selected embodiments, the table may also include a status indicating the availability of the station. For example, a particular station may be down for maintenance and therefore may not be used to detect the object 100.

FIG. 13 is an exemplary block diagram of the server according to one example. In FIG. 13, the server 200 includes a CPU 1300 which performs the processes described above. The process data and instructions may be stored in memory 1302. These processes and instructions may also be stored on a storage medium disk 1304 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the server 200 communicates, such as a server or computer.

Further, the claimed advancements may be provided as a utility application, background daemon, or component of an operating system, or combination thereof, executing in conjunction with CPU 1300 and an operating system such as Microsoft Windows 7, UNIX, Solaris, LINUX, Apple MAC-OS and other systems known to those skilled in the art.

CPU 1300 may be a Xenon or Core processor from Intel of America or an Opteron processor from AMD of America, or may be other processor types that would be recognized by one of ordinary skill in the art. Alternatively, the CPU 1300 may be implemented on an FPGA, ASIC, PLD or using discrete logic circuits, as one of ordinary skill in the art would recognize. Further, CPU 1300 may be implemented as multiple processors cooperatively working in parallel to perform the instructions of the inventive processes described above.

The server 200 in FIG. 13 also includes a network controller 1306, such as an Intel Ethernet PRO network interface card from Intel Corporation of America, for interfacing with network 202. As can be appreciated, the network 202 can be a public network, such as the Internet, or a private network such as an LAN or WAN network, or any combination thereof and can also include PSTN or ISDN sub-networks. The network 202 can also be wired, such as an Ethernet network, or can be wireless such as a cellular network including EDGE, 3G and 4G wireless cellular systems. The wireless network can also be WiFi, Bluetooth, or any other wireless form of communication that is known.

The server 200 further includes a display controller 1308, such as a NVIDIA GeForce GTX or Quadro graphics adaptor from NVIDIA Corporation of America for interfacing with display 1310, such as a Hewlett Packard HPL2445w LCD monitor. A general purpose I/O interface 1312 interfaces with a keyboard and/or mouse 1314 as well as a touch screen panel 1316 on or separate from display 1310. General purpose I/O interface also connects to a variety of peripherals 1318 including printers and scanners, such as an OfficeJet or DeskJet from Hewlett Packard.

A sound controller 1320 is also provided in the server 200, such as Sound Blaster X-Fi Titanium from Creative, to interface with speakers/microphone 1322 thereby providing sounds and/or music.

The general purpose storage controller 1324 connects the storage medium disk 1304 with communication bus 1326, which may be an ISA, EISA, VESA, PCI, or similar, for interconnecting all of the components of the server 200. A description of the general features and functionality of the display 1310, keyboard and/or mouse 1314, as well as the display controller 1308, storage controller 1324, network controller 1306, sound controller 1320, and general purpose I/O interface 1312 is omitted herein for brevity as these features are known.

A system which includes the features in the foregoing description provides numerous advantages to users. In particular, the system and associated methodology determines the 3D position of the object with a high accuracy using a hybrid algorithm. Thus, the present disclosure provides an improvement to the technical field of navigation, mobile phone tracking, unmanned underwater vehicle tracking, and the like. In addition, the presented method may be applied to rapid deployment positioning system in the emergency domains, such as firefighting, security, and military missions. The presented method can be applied to indoor or outdoor localization. With the rapid development of wireless sensor networks, location information becomes critically essential and indispensable. In many applications, it is important to associate sensed data with locations.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

1. A method for determining a 3D position of an object, the method comprising:
calculating, using processing circuitry, time difference of arrival (TDOA) measurements based on time of arrival of signals;
calculating, using the processing circuitry, a nuisance parameter based on the TDOA measurements;
refining, using the processing circuitry, a vertical position of the object based on at least the nuisance parameter;
calculating, using the processing circuitry, horizontal coordinates of the object as a function of a closed form extended single set least squares solution based on the TDOA measurements and a plurality of stations' position; and
sending the 3D position of the object to an external device to provide enhanced position data to host applications.

2. The method of claim 1, wherein the TDOA measurements are based on the time of arrival of signals from a plurality of stations.

3. The method of claim 1, wherein the TDOA measurements are based on the time of arrival of signals received at a plurality of stations.

4. The method of claim 1, wherein the nuisance parameter is a function of a closed form single set least squares (CFSSLS) solution.

5. The method of claim 4, wherein the refinement of the vertical position of the object is based on at least the nuisance parameter and horizontal coordinates of the object obtained from the CFSSLS solution.

6. The method of claim 1, wherein the nuisance parameter is a function of a closed form full set least squares (CFFSLS) solution.

7. The method of claim 6, wherein the refinement of the vertical position of the object is based on at least the nuisance parameter and horizontal coordinates of the object obtained from the CFFSLS solution.

8. The method of claim 2, wherein the object is a receiver.

9. The method of claim 2, wherein each of the plurality of stations includes at least one transmitter.

10. The method of claim 3, wherein the object is a transmitter.

11. The method of claim 3, wherein each of the plurality of stations includes at least one receiver.

12. The method of claim 1, wherein the nuisance parameter is a range from a reference station to the object.

13. The method of claim 12, wherein the reference station is determined based on a minimization procedure.

14. The method of claim 12, wherein the reference station is determined based on the accuracy of the plurality of stations' position.

15. The method of claim 1, further comprising:
calculating horizontal coordinates of the object as a function of a closed form full set least squares when a full set of the TDOA measurements is available; and
refining the vertical position of the object based on the horizontal coordinates when the closed form full set least squares solution has a higher accuracy than the closed form extended single set least squares solution.

16. A system for determining a 3D position of an object, the system comprising:
a plurality of stations; and
a device having processing circuitry configured to
calculate time difference of arrival (TDOA) measurements based on time of arrival signals with respect to the plurality of stations,
calculate a nuisance parameter based on the TDOA measurements,
refine a vertical position of the object based on at least the nuisance parameter,
calculate horizontal coordinates of the object as a function of a closed form extended single set least squares solution based on the TDOA measurements and the plurality of stations' position, and
send the 3D position of the object to an external device to provide enhanced position data to host applications.

17. A device for determining a 3D position, the device comprising:
processing circuitry configured to
calculate time difference of arrival (TDOA) measurements based on time of arrival signals with respect to a plurality of stations,
calculate a nuisance parameter based on the TDOA measurements,
refine a vertical position of the object based on at least the nuisance parameter,
calculate horizontal coordinates of the object as a function of a closed form extended single set least squares solution based on the TDOA measurements and the plurality of stations' position, and
send the 3D position of the object to an external device to provide enhanced position data to host applications.
